(19) United States
(12) Patent Application Publication
(10) Pub. No.: US 2015/0288676 A1
(43) Pub. Date: Oct. 8, 2015

(54) MOBILE TERMINAL-BASED AUTOMATIC LOGON PROCESSING METHOD AND SYSTEM

(71) Applicant: HUIZHOU TCL MOBILE COMMUNICATION CO., LTD., HUIZHOU, GD (CN)

(72) Inventor: Hanlin Guo, Huizhou (CN)

(21) Appl. No.: 14/439,102

(22) PCT Filed: Apr. 16, 2014
(86) PCT No.: PCT/CN2014/075514

§ 371 Date: Apr. 28, 2015

(30) Foreign Application Priority Data
Aug. 14, 2013 (CN) 201310352890.8

(51) Int. Cl. H04L 29/06

(52) U.S. Cl. CPC H04L 63/083; H04L 63/12

(57) ABSTRACT

A mobile terminal-based automatic logon processing method and system may include a mobile terminal that creates a logon list that stores user names and passwords used to successfully log on to a web page or application, as well as tags corresponding to the user names and passwords. When a user needs to automatically log on a target web page or a target application, the mobile terminal may acquire the tags corresponding to the target web page or the target application according to the logon list and automatically enters the user name and password into the target web page or the target application. Thereby, the mobile terminal performs automatic logon to the target web page or the target application.

### TECHNICAL FIELD

The present disclosure relates to the field of mobile terminals. More particularly, the present disclosure relates to a mobile terminal-based automatic logon processing method and system.

### BACKGROUND

Intelligent mobile terminals, in particular smart phones, have gradually replaced most of the functions of personal computers and laptop computers. As a result, people are now using mobile terminals, such as smart phones, when going online. Moreover, many applications on personal computers (PCs) can be used on smart phones. Many cell phone applications involve logon of personal accounts, and many Internet web pages also require logon of user accounts. However, unlike personal computers, cell phones do not typically have a convenient keyboard for input.

Furthermore, in current browsers and various applications on cell phones, almost all actions related to logon have functions to remember passwords which are limited. For example, while a browser cache will automatically remember a user name and a password, only the user name and password for the user information of the last logon is retained within the browser cache. Once a user needs to exit and log on again by switching to another user name, it is also necessary to exit and log on again to the application. Another drawback of current methods is that if a cache stores user account information, there is a risk of loss, as the cached information is not encrypted.

Therefore, the prior art needs to be improved and developed.

### SUMMARY

The present invention provides a mobile terminal-based automatic logon processing method and system. With the logon method and system according to the present invention, a user can automatically log on a target web page and a target application without inputting a user name and password. Furthermore, security of a user password can be ensured, which makes it convenient for the user.

A mobile terminal-based automatic logon processing method includes when a mobile terminal detects that a user inputs a user name and password, and the user successfully logs onto a web page or application, said mobile terminal prompts the user to input a tag, and the mobile terminal establishes a corresponding relation between said tag and said user name and password, as well as a corresponding relation between said tag and said web page or application; said mobile terminal creates a logon list that stores a plurality of user names and passwords, used to successfully log on web pages or applications, as well as, a plurality of tags corresponding to respective user names and passwords, according to user operations; when a user logs onto a target web page or a target application, the mobile terminal acquires a stored tag corresponding to said target web page or said target application according to said logon list; said mobile terminal automatically opens the target web page or the target application corresponding to said stored tag, acquires a stored user name and password corresponding to said target web page or said target application according to said logon list, and automatically enters said user name and password into said target web page or said target application.

In another embodiment, a mobile terminal-based automatic logon processing method includes installing a password safe application on the mobile terminal, and storing user names and passwords used by a user to successfully log on a web page or application with said password safe application.

In a further embodiment, a mobile terminal-based automatic logon processing method includes, during a first use of a password safe application by a user, carrying out registration, filling in registration information, and inputting a verification code.

In yet another embodiment, a mobile terminal-based automatic logon processing method includes, when a password safe application detects that a user inputs a user name and password for logon to a web page or application, determining if the user inputs a control command to record said user name and password; if the user inputs a control command to record said user name and password, said password safe application receives a tag that the user sets for said password; said password safe application automatically detects if the logon to the web page or application is successful after the user inputs the user name and password; if the logon is successful, treats the tag set by the user as a valid tag and said password safe application stores said tag and the user name and password corresponding to said tag; if the logon fails, when said password safe application detects that a user inputs a user name and password for logon to a web page or application, determines if the user inputs a control command to record said user name and password; and if the user does not input a control command to record said user name and password, does not record the user name and password that the user inputs.

In yet a further embodiment, a mobile terminal-based automatic logon processing method includes, when a user successfully logs on a password safe application, the user acquires a logon list; and the user acquires and selects a tag corresponding to a target web page or a target application according to said logon list.

In another embodiment, a mobile terminal-based automatic logon processing method includes, when a password safe application determines, according to a tag selected by a user, that the user wants to automatically log onto a web page, said password safe application automatically opens a browser, and controls said browser to automatically go to the target web page that the user wants to log onto; and said password safe application acquires a user name and password corresponding to said target web page according to said logon list, and automatically enters said acquired user name and password into said target web page.

In a further embodiment, a mobile terminal-based automatic logon processing method includes, further comprising when a password safe application determines, according to the tag selected by a user, that the user wants to automatically log onto an application, said password safe application determines if a target application for automatic logon has been uninstalled; if the target application for automatic logon has not been uninstalled, said password safe application automatically opens said target application, acquires a user name and password corresponding to said target application according to a logon list, and automatically enters said user name and password into said target application; and if said target application does not exist, prompts the user that said target application does not exist.

In yet another embodiment, a mobile terminal-based automatic logon processing method includes, when a user registers for a password safe application of the mobile terminal, the user enters a verification code; when the user logs onto said password safe application, said password safe application determines if a current verification code, entered by the user, is consistent with the verification code entered by the user during registration; if the current verification code is determined to be consistent with the verification code entered by the user during registration, the logon is successful and said password safe application detects if the user inputs a user name and password for logon to a web page or application; when the mobile terminal detects that the user inputs a user name and password, and successfully logs on a web page or application, said mobile terminal prompts the user to input a tag, and establishes a corresponding relation between said tag and said user name and password, as well as a corresponding relation between said tag and said web page or application; said mobile terminal creates a logon list, and the logon list stores a plurality of user names and passwords used to successfully log on web pages or applications, as well as, respective tags corresponding to said user names and passwords, according to user operations; when a user logs onto a target web page or a target application, the mobile terminal acquires the tag corresponding to said target web page or said target application according to said logon list; said mobile terminal automatically opens the target web page or target application corresponding to said tag, acquires the user name and password corresponding to said target web page or said target application, according to said logon list, and automatically enters said user name and password into said target web page or said target application; and if the current verification code is determined to not be consistent with the verification code entered by the user during registration, prompts the user to input the verification code again.

In yet a further embodiment, a mobile terminal-based automatic logon processing method includes installing a password safe application on the mobile terminal, and storing user names and passwords used by a user to successfully log onto a web page or application with said password safe application.

In another embodiment, a mobile terminal-based automatic logon processing method includes, during a first time use of said password safe application by a user, carrying out registration, filling in registration information, and inputting a verification code.

In a further embodiment, a mobile terminal-based automatic logon processing method includes, when a password safe application detects that a user inputs a user name and password for logon to a web page or application, determining if the user inputs a control command to record said user name and password; if the user inputs a control command to record said user name and password, said password safe application receives a tag that the user sets for said password; said password safe application automatically detects if the logon to the web page or application is successful after the user inputs the user name and password; if the logon is successful, treats the tag set by the user as a valid tag and said password safe application stores said tag and the user name and password corresponding to said tag; if the logon fails, when said password safe application detects that a user inputs a user name and password for logon to a web page or application, determines if the user inputs a control command to record said user name and password; and if the user does not input a control command to record said user name and password, does not record the user name and password that the user inputs.

In yet another embodiment, a mobile terminal-based automatic logon processing method includes, when a user successfully logs on a password safe application, the user acquires a logon list; and the user acquires and selects a tag corresponding to a target web page or a target application according to said logon list.

In yet a further embodiment, a mobile terminal-based automatic logon processing method includes, when a password safe application determines, according to a tag selected by a user, that the user wants to automatically log onto a web page, said password safe application automatically opens a browser, and controls said browser to automatically go to a target web page that the user wants to log onto; and said password safe application acquires a user name and password corresponding to a target web page according to a logon list, and automatically enters said acquired user name and password into said target web page.

In another embodiment, a mobile terminal-based automatic logon processing method includes, when a password safe application determines, according to the tag selected by a user, that the user wants to automatically log onto an application, said password safe application determines if a target application for automatic logon has been uninstalled; if the target application for automatic logon has not been uninstalled, said password safe application automatically opens said target application, acquires a user name and password corresponding to said target application according to a logon list, and automatically enters said user name and password into said target application; and if said target application does not exist, prompts the user that said target application does not exist.

In a further embodiment, a mobile terminal-based automatic logon system includes a tag establishment module that, when a mobile terminal detects that a user inputs a user name and password and successfully logs on a web page or application, causes said mobile terminal to prompt the user to input a tag, and to establish a corresponding relation between said tag and said user name and password, as well as, to establish a corresponding relation between said tag and said web page or application; a logon list creating module for creating a logon list storing a plurality of user names and passwords, used to successfully log on web pages or applications, as well as, respective tags corresponding to said user names and passwords, according to user operations; a tag acquisition module for acquiring the tag corresponding to said target web page or said target application according to said logon list; and an automatic logon control module for automatically opening the target web page or target application corresponding to said tag, acquiring the user name and password corresponding to said target web page or said target application according to said logon list, and automatically entering said user name and password into said target web page or said target application.

In yet another embodiment, a mobile terminal-based automatic logon system includes a logon control module that, when a user logs on a password safe application, causes said password safe application to determine if a current verification code entered by the user is consistent with a verification code entered by the user during registration; if the current verification code is determined to be consistent with the verification code entered during registration, logon is successful, and said password safe application detects if the user inputs a user name and password for logon to a web page or application.

In yet a further embodiment, a mobile terminal-based automatic logon system includes a control command determination unit for, when a password safe application detects that a user inputs a user name and password for logon to a web page or application, determining if the user inputs a control command to record said user name and password; a tag setup unit that, when the control command determination unit determines that the user inputs a control command to record said user name and password, causes said password safe application to receive a tag that the user sets for said password; a logon determination unit for automatically detecting if the logon to the web page or application is successful after the user inputs the user name and password; if the logon is successful, treating the tag set by the user as a valid tag; a storing unit for storing said tag and the user name and password corresponding to said tag.

In another embodiment, a mobile terminal-based automatic logon system includes a web page selection control unit that, when a password safe application determines, according to a tag selected by the user, that the user wants to automatically log on a web page, causes said password safe application automatically open a browser, and controls said browser to automatically go to a target web page that the user wants to log on; a web page automatic logon unit for acquiring a user name and password corresponding to said target web page according to a logon list, and automatically entering said acquired user name and password into said target web page an application selection control unit that, when said password safe application determines, according to the tag selected by the user, that the user wants to automatically log on an application, causes said password safe application to determine if the target application for automatic logon has been uninstalled; and an application automatic logon unit that, when said password safe application determines that the target application for automatic logon has not been uninstalled, causes said password safe application to automatically open said target application, acquire the user name and password corresponding to said target application according to said logon list, and automatically enter said user name and password into said target application, thereby automatically logging on the target application.

A mobile terminal-based automatic logon processing method and system may install a password safe application on a mobile terminal, and establish a corresponding relation between a tag and a user name and password, as well as, a corresponding relation between the tag and a web page or application through a logon list therein. As a result, when a user wishes to log on a web page or application, the user selects a tag corresponding to said target web page or said target application according to said logon list, and does not need to input a user name or password during the process of automatic logon. Thereby, a mobile terminal-based automatic logon processing method and system saves time for logon, avoids inconvenience in using a mobile terminal to input a user name and password, and results in convenience for the user.

### BRIEF DESCRIPTION OF THE DRAWINGS

FIG. 1 depicts a flow chart of an exemplary mobile terminal-based automatic logon processing method according to the present invention;

FIG. 2 depicts a flow chart of exemplary details of a portion of the flow chart depicted in FIG. 1;

FIG. 3 depicts a flow chart of exemplary details of a portion of the flow chart depicted in FIG. 1; and

FIG. 4 depicts a functional block diagram of an exemplary mobile terminal-based automatic logon system according to the present invention.

### DETAILED DESCRIPTION

To make the objects, technical solutions and effects of the present invention clear, the present invention will be described in detail with reference to the accompanying drawings and exemplary embodiments. It should be understood that the exemplary embodiments are included for illustrative purposes. The exemplary embodiments are not intended to limit the scope of present invention in any way.

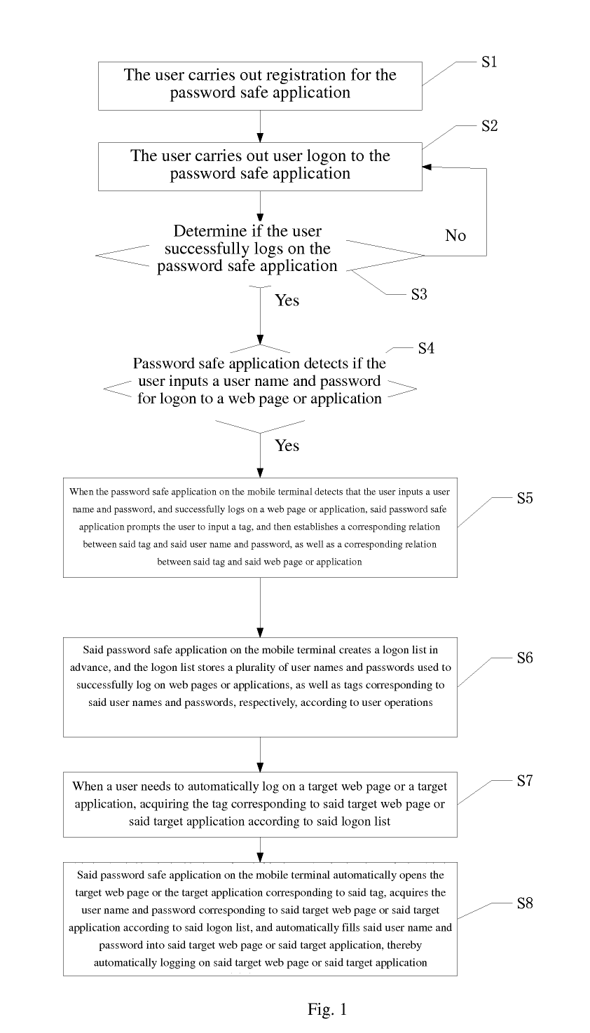

Turning to FIG. 1, a flow chart of a mobile terminal-based automatic logon processing method is depicted. A user may install a password safe application on a mobile terminal, and may store user names and passwords, used by the user to successfully log onto a web page or application, with the password safe application. Subsequently, when the user wishes to acquire a logon password, the user may input a verification code and, when the verification code inputted by the user is correct, the user may acquire a user name and password corresponding to the web page or application. Thereby, safety of the password and avoiding potential safety hazard of password leakage is ensured.

A hardware configuration of a mobile terminal may be changed such that the mobile terminal can automatically implement the method for automatically logging on a web page or application according to the present invention without relying on other applications. When a user completes an installation of a password safe application on the mobile terminal, the user may carry out registration for the password safe application (block S1). For example, during a first time use of the password safe application, the user may carry out registration, fill in registration information, and input a verification code. Subsequently, the user may carry out user logon to the password safe application (block S2). For example, when the user registration is completed, to use the password safe application, a verification code may be inputted, and when the user inputs said verification code, the method may determine if the user successfully logs on the password safe application (block S3). For example, the password safe application may determine if the verification code inputted by the user during registration is consistent with a current verification code inputted by the user during logon. If the current verification code is determined to be consistent with the verification code entered during registration of the password safe application, the method may determine that the user logon is successful. If the current verification code is determined to not be consistent with the verification code entered during registration of the password safe application, the method may determine that the user logon has failed, and may return to block S2. When the user logon is successful, the password safe application may detect if the user inputs a user name and password for logon to a web page or application. For example, when the user logon is successful, the password safe application may enter a detection mode, which may detect if the user triggers an action having input box properties for user name and password. When the password safe application on the mobile terminal detects that the user inputs a user name and password (block S5), and the user successfully logs on a web page or application, the password safe application may prompt the user to input a tag. Subsequently, the method may establish a corresponding relation between the tag and the user name and password, as well as, establish a corresponding relation between the tag and the web page or application.

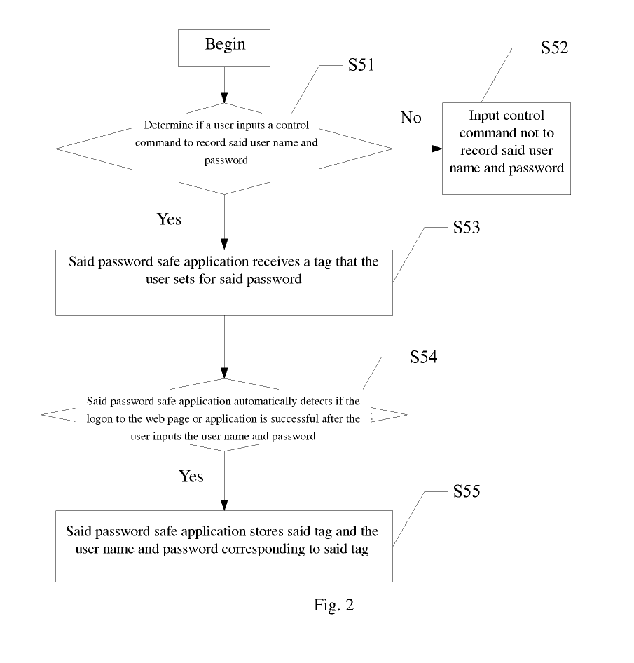

With reference to FIG. 2, when the password safe application detects that the user inputs a user name and password to log on a web page or application, the method may determine if the user inputs a control command to record said user name and password (block S51). For example, when the password safe application detects that the user logs on a web page or application, the method may automatically display a dialog box, through which the user may select whether to store a user name and password inputted when logging onto the web page or application. When the user selects to store the user name and password, a control command to record the user name and password may be entered and the method may proceed to block S53. When the user selects not to store the user name and password, a control command not to record the user name and password may be inputted (block S52). The password safe application may receive a tag that the user sets for the password (block S53). For example, the user may set the tag according to the user's own use habit, easiness to remember, and other factors. The password safe application may generate a tag automatically for the user to select, and may establish a one-to-one corresponding relation among tag—user name—password—web page or application. The password safe application may automatically detect if logon to the web page or application is successful after the user inputs the user name and password (block S54). When the logon fails, i.e. when the user inputs an incorrect user name and password, the method may return to block S4, and the password safe application may continue to detect entry of a user name and password. When the logon is successful, i.e. when the user inputs the correct user name and password, the password safe application may store the tag, and the user name and password corresponding to the tag (block S55).

By establishing the tag, the method may enable a mobile terminal to achieve accurate positioning during subsequent quick logon. As further illustrated in FIG. 1, the password safe application on the mobile terminal may create a logon list that may store a plurality of user names and passwords used to successfully log on web pages or applications, as well as, respective tags corresponding to the user names and passwords, according to user operations (block S6). For example, the logon list may use tags as indexes to correspondingly store user names and passwords. When a user wishes to automatically log onto a target web page or a target application, the method may include acquiring a tag corresponding to the target web page or the target application according to the logon list (block S7).

When a user wishes to automatically log onto a target web page or a target application, the user may log onto a password safe application (block S71). When the user successfully logs onto the password safe application, the user may acquire a logon list (block S72). The user may acquire and select the tag corresponding to the target web page or the target application according to the logon list (block S73).

The password safe application, on a mobile terminal may automatically open the target web page or the target application corresponding to the tag, may acquire a user name and password corresponding to the target web page or the target application according to a logon list, and may automatically enter the user name and password into the target web page or the target application. Thereby, the mobile terminal may automatically log onto the target web page or the target application (block S8).

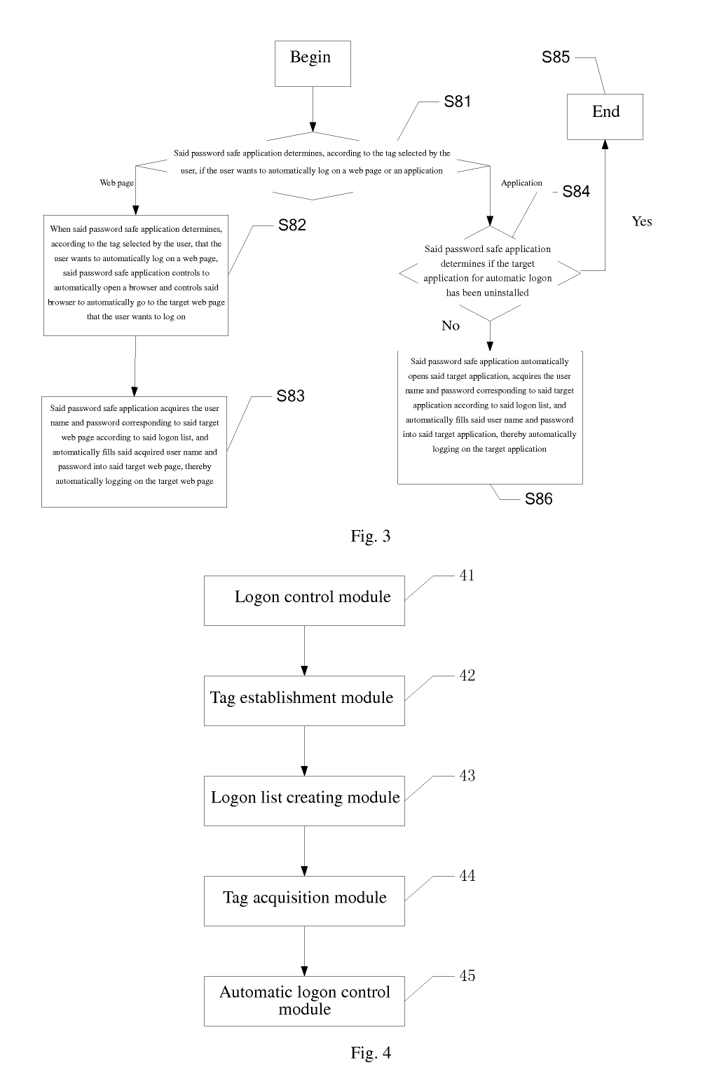

Turning to FIG. 3, a password safe application may determine, according to a tag selected by the user, if the user wants to automatically log onto a web page or an application (block S81). When the method determines that the user wants to log onto a web page, the password safe application may determine, according to a tag selected by the user, that the user wants to automatically log onto a web page, the password safe application may automatically open a browser and may control the browser to automatically go to the target web page that the user wants to log onto (block S82). The user may confirm a valid and useable network connection such that the mobile terminal can smoothly go to the target web page that the user wants to log onto. The password safe application may acquire a user name and password corresponding to the target web page according to a logon list, and may automatically enter the acquired user name and password into the target web page (block S83). Thereby, the method may automatically log onto the target web page. For example, the password safe application may automatically enter the user name and password into the target web page, thus, achieving automatic logon to the target web page. When the method determines that the user wants to log onto a target application, the password safe application may determine if the target application for automatic logon has been uninstalled (block S84). If the target application has been determined to be uninstalled, the method may end (block S85). If the target application is determined to not be uninstalled, the password safe application may automatically open the target application, may acquire the user name and password corresponding to the target application according to a logon list, and may automatically enter the user name and password into the target application (block S86), thereby, automatically logging onto the target application.

With the above mobile terminal-based automatic logon processing method, the password safe application may store multiple groups of user names and passwords for the same web page or the same application, such that different users can automatically log onto the web page or the application without making frequent inputs. Moreover, use of the password safe application may enable a user to automatically log onto a web page or an application according to a self-set tag. Thereby, eliminating a step when a user opens a browser and opens an application, and making it convenient for the user. In addition, identity verification may be required when a user uses the password safe application, which safeguards the user's privacy.

With reference to FIG. 4, a mobile terminal-based automatic logon system may include a logon control module 41 that, when a user registers for a password safe application of the mobile terminal, the user may input a verification code. Subsequently, when the user logs onto the password safe application, the password safe application may determine if a currently entered verification code, inputted by the user, is consistent with the verification code inputted by the user during registration. If the currently entered verification code is determined to be consistent with the verification code entered during registration of the password safe application, the logon may be successful, and the password safe application may detect if the user inputs a user name and password for logon to a web page or application. A mobile terminal-based automatic logon system may further include a tag establishment module 42 that, when a mobile terminal detects that a user inputs a user name and password and successfully logs on a web page or application, may cause the mobile terminal to prompt the user to input a tag, and may establish a corresponding relation between said tag and said user name and password, as well as a corresponding relation between the tag and the web page or application. A mobile terminal-based automatic logon system may also include a logon list creating module 43 for creating a logon list that may store a plurality of user names and passwords stored on the mobile terminal and used to successfully log on web pages or applications, as well as, respective tags corresponding to the user names and passwords, according to user operations. A mobile terminal-based automatic logon system may further include a tag acquisition module 44 that, when a user wishes to automatically log onto a target web page or a target application, may acquire the tag corresponding to the target web page or the target application according to the logon list. A mobile terminal-based automatic logon system may also include an automatic logon control module 45 that may automatically open the target web page or target application corresponding to the tag, may acquire the user name and password corresponding to the target web page or the target application according to a logon list, and may automatically enter the user name and password into the target web page or the target application. Thereby, performing automatic logon to the target web page or the target application.

The tag establishment module 42 may include a control command determination unit 421 that, when the password safe application detects that a user inputs a user name and password for logon to a web page or application, may determine if the user inputs a control command to record the user name and password. The tag establishment module 42 may also include a tag setup unit 422 that, when it is determined that the user inputs a control command to record the user name and password, may cause the password safe application to receive a tag that the user sets for the password. The tag establishment module 42 may further include a logon determination unit 423 that may automatically detect if logon to the web page or application is successful after the user inputs the user name and password. If the logon is successful, the tag establishment module 42 may treat the tag set by the user as a valid tag. The tag establishment module 42 may also include a storing unit 424 for storing the tag, and the user name and password corresponding to the tag.

The tag acquisition module 44 may include a logon list acquisition unit 441 that, when the user successfully logs onto the password safe application, the user may acquire the logon list. The tag acquisition module 44 may also include a tag acquisition unit 442 for acquiring and selecting the tag corresponding to the target web page or the target application according to the logon list.

The automatic logon control module 45 may include a web page selection control unit 451 that, when the password safe application determines, according to the tag selected by the user, that the user wants to automatically log onto a web page, may cause the password safe application to automatically open a browser, and may control the browser to automatically go to the target web page that the user wants to log onto. The automatic logon control module 45 may also include a web page automatic logon unit 452 that may acquire the user name and password corresponding to the target web page according to the logon list, and may automatically enter the acquired user name and password into the target web page, thereby, automatically logging onto the target web page. The automatic logon control module 45 may further include an application selection control unit 453 that, when the password safe application determines, according to the tag selected by the user, that the user wants to automatically log onto an application, may cause the password safe application to determine if the target application for automatic logon has been uninstalled. The automatic logon control module 45 may also include an application automatic logon unit 454 that, when the password safe application determines that the target application for automatic logon has not been uninstalled, may cause the password safe application to automatically open the target application, may acquire the user name and password corresponding to the target application according to the logon list, and may automatically enter the user name and password into the target application, thereby, automatically logging onto the target application.

In summary, with the mobile terminal-based automatic logon processing method and system according to the present invention, a user may correlate web pages and applications, that are frequently accessed on a mobile terminal, to user names and passwords. Thereby, storage of the user names and passwords by the applications and browser cache may be eliminated. Thereby, the method and systems may improve security of password storage, and may avoid the risk of privacy leakage. Moreover, when the user wishes to log onto a web page or an application, the user can directly log on the web page or the application by selecting a tag corresponding to the web page or the application, which avoids the inconvenience caused by repeated inputs of user names and passwords by the user. In addition, when different users use the mobile terminal, automatic logon can be performed setting a tag for the web page or application, which may makes logon convenient for the users.

It should be understood that applications of the present invention are not limited to the above examples. To those skilled in the art, improvements or modifications may be made according to the above description, and all of these improvements or modifications shall be encompassed by the appended claims.

1. A mobile terminal-based automatic logon processing method, the method comprising:
when a mobile terminal detects that a user inputs a user name and password, and the user successfully logs onto a web page or application, said mobile terminal prompts the user to input a tag, and the mobile terminal establishes a corresponding relation between said tag and said user name and password, as well as a corresponding relation between said tag and said web page or application;
said mobile terminal creates a logon list that stores a plurality of user names and passwords, used to successfully log on web pages or applications, as well as, a plurality of tags corresponding to respective user names and passwords, according to user operations;
when a user logs onto a target web page or a target application, the mobile terminal acquires a stored tag corresponding to said target web page or said target application according to said logon list;
said mobile terminal automatically opens the target web page or the target application corresponding to said stored tag, acquires a stored user name and password corresponding to said target web page or said target application according to said logon list, and automatically enters said user name and password into said target web page or said target application.

2. The mobile terminal-based automatic logon processing method according to claim 1, further comprising:
installing a password safe application on the mobile terminal, and storing user names and passwords used by a user to successfully log on a web page or application with said password safe application.

3. The mobile terminal-based automatic logon processing method according to claim 2, further comprising:
during a first use of said password safe application by a user, carrying out registration, filling in registration information, and inputting a verification code.

4. The mobile terminal-based automatic logon processing method according to claim 2, wherein,
when said password safe application detects that a user inputs a user name and password for logon to a web page or application, determines if the user inputs a control command to record said user name and password;
if the user inputs a control command to record said user name and password,
said password safe application receives a tag that the user sets for said password;
said password safe application automatically detects if the logon to the web page or application is successful after the user inputs the user name and password;
if the logon is successful, treats the tag set by the user as a valid tag and
said password safe application stores said tag and the user name and password corresponding to said tag;
if the logon fails, when said password safe application detects that a user inputs a user name and password for logon to a web page or application, determines if the user inputs a control command to record said user name and password; and
if the user does not input a control command to record said user name and password, does not record the user name and password that the user inputs.

5. The mobile terminal-based automatic logon processing method according to claim 1, wherein,
when the user successfully logs on said password safe application, the user acquires said logon list; and
the user acquires and selects the tag corresponding to said target web page or said target application according to said logon list.

6. The mobile terminal-based automatic logon processing method according to claim 5, wherein,
when said password safe application determines, according to the tag selected by the user, that the user wants to automatically log onto a web page, said password safe application automatically opens a browser, and controls said browser to automatically go to the target web page that the user wants to log onto; and
said password safe application acquires the user name and password corresponding to said target web page according to said logon list, and automatically enters said acquired user name and password into said target web page.

7. The mobile terminal-based automatic logon processing method according to claim 6, further comprising:
when said password safe application determines, according to the tag selected by the user, that the user wants to automatically log onto an application, said password safe application determines if the target application for automatic logon has been uninstalled; if the target application for automatic logon has not been uninstalled,
said password safe application automatically opens said target application, acquires the user name and password corresponding to said target application according to said logon list, and automatically enters said user name and password into said target application; and
if said target application does not exist, prompts the user that said target application does not exist.

8. A mobile terminal-based automatic logon processing method, the method comprising:
when a user registers for a password safe application of the mobile terminal, the user enters a verification code;
when the user logs onto said password safe application, said password safe application determines if a current verification code, entered by the user, is consistent with a verification code entered by the user during registration; if the current verification code is determined to be consistent with the verification code entered by the user during registration, the logon is successful and
said password safe application detects if the user inputs a user name and password for logon to a web page or application;
when the mobile terminal detects that the user inputs a user name and password, and successfully logs on a web page or application, said mobile terminal prompts the user to input a tag, and establishes a corresponding relation between said tag and said user name and password, as well as a corresponding relation between said tag and said web page or application;
said mobile terminal creates a logon list, and the logon list stores a plurality of user names and passwords used to successfully log on web pages or applications, as well as, respective tags corresponding to said user names and passwords, according to user operations;
when a user logs onto a target web page or a target application, the mobile terminal acquires the tag corresponding to said target web page or said target application according to said logon list;
said mobile terminal automatically opens the target web page or target application corresponding to said tag, acquires the user name and password corresponding to said target web page or said target application, according to said logon list, and automatically enters said user name and password into said target web page or said target application; and
if the current verification code is determined to not be consistent with the verification code entered by the user during registration, prompts the user to input the verification code again.

9. The mobile terminal-based automatic logon processing method according to claim 8, further comprising:
installing a password safe application on the mobile terminal, and storing user names and passwords used by a user to successfully log onto a web page or application with said password safe application.

10. The mobile terminal-based automatic logon processing method according to claim 9, further comprising:
during a first time use of said password safe application by a user, carrying out registration, filling in registration information, and inputting a verification code.

11. The mobile terminal-based automatic logon processing method according to claim 8, wherein,
when said password safe application detects that a user inputs a user name and password for logon to a web page or application, determines if the user inputs a control command to record said user name and password;
if the user inputs a control command to record said user name and password,
said password safe application receives a tag that the user sets for said password;
said password safe application automatically detects if the logon to the web page or application is successful after the user inputs the user name and password;
if the logon is successful, treats the tag set by the user as a valid tag and
said password safe application stores said tag and the user name and password corresponding to said tag;
if the logon fails, when said password safe application detects that a user inputs a user name and password for logon to a web page or application, determines if the user inputs a control command to record said user name and password; and
if the user does not input a control command to record said user name and password, does not record the user name and password that the user inputs.

12. The mobile terminal-based automatic logon processing method according to claim 8, wherein,
when the user successfully logs on said password safe application, the user acquires said logon list; and
the user acquires and selects the tag corresponding to said target web page or said target application according to said logon list.

13. The mobile terminal-based automatic logon processing method according to claim 12, wherein,
when said password safe application determines, according to the tag selected by the user, that the user wants to automatically log onto a web page, said password safe application automatically opens a browser, and controls said browser to automatically go to the target web page that the user wants to log onto; and
said password safe application acquires the user name and password corresponding to said target web page according to said logon list, and automatically enters said acquired user name and password into said target web page.

14. The mobile terminal-based automatic logon processing method according to claim 13, further comprising:
when said password safe application determines, according to the tag selected by the user, that the user wants to automatically log onto an application, said password safe application determines if the target application for automatic logon has been uninstalled; if the target application for automatic logon has not been uninstalled,
said password safe application automatically opens said target application, acquires the user name and password corresponding to said target application according to said logon list, and automatically enters said user name and password into said target application, thereby automatically logging on the target application; and
if said target application does not exist, prompts the user that said target application does not exist.

15. A mobile terminal-based automatic logon system, the system comprising:
a tag establishment module that, when a mobile terminal detects that a user inputs a user name and password and successfully logs on a web page or application, causes said mobile terminal to prompt the user to input a tag, and to establish a corresponding relation between said tag and said user name and password, as well as, to establish a corresponding relation between said tag and said web page or application;
a logon list creating module for creating a logon list storing a plurality of user names and passwords, used to successfully log on web pages or applications, as well as, respective tags corresponding to said user names and passwords, according to user operations;
a tag acquisition module for acquiring the tag corresponding to said target web page or said target application according to said logon list; and
an automatic logon control module for automatically opening the target web page or target application corresponding to said tag, acquiring the user name and password corresponding to said target web page or said target application according to said logon list, and automatically entering said user name and password into said target web page or said target application.

16. The mobile terminal-based automatic logon system according to claim 19, further comprising:
a logon control module that, when the user logs on said password safe application, causes said password safe application to determine if a current verification code entered by the user is consistent with the verification code entered by the user during registration; if the current verification code is determined to be consistent with the verification code entered during registration, the logon is successful, and said password safe application detects if the user inputs a user name and password for logon to a web page or application.

17. The mobile terminal-based automatic logon system according to claim 16, wherein
a control command determination unit for, when said password safe application detects that a user inputs a user name and password for logon to a web page or application, determining if the user inputs a control command to record said user name and password;
a tag setup unit that, when the control command determination unit determines that the user inputs a control command to record said user name and password, causes said password safe application to receive a tag that the user sets for said password;
a logon determination unit for automatically detecting if the logon to the web page or application is successful after the user inputs the user name and password; if the logon is successful, treating the tag set by the user as a valid tag;
a storing unit for storing said tag and the user name and password corresponding to said tag.

18. The mobile terminal-based automatic logon system according to claim 19, wherein said automatic logon control module comprises:
a web page selection control unit that, when said password safe application determines, according to the tag selected by the user, that the user wants to automatically log on a web page, causes said password safe application to automatically open a browser, and controls said browser to automatically go to the target web page that the user wants to log on;
a web page automatic logon unit for acquiring the user name and password corresponding to said target web page according to said logon list, and automatically entering said acquired user name and password into said target web page;
an application selection control unit that, when said password safe application determines, according to the tag selected by the user, that the user wants to automatically log on an application, causes said password safe application to determine if the target application for automatic logon has been uninstalled; and
an application automatic logon unit that, when said password safe application determines that the target application for automatic logon has not been uninstalled, causes said password safe application to automatically open said target application, acquire the user name and password corresponding to said target application according to said logon list, and automatically enter said user name and password into said target application, thereby automatically logging on the target application.

19. The mobile terminal-based automatic logon system according to claim 15, further comprising:
installing a password safe application on the mobile terminal, and storing user names and passwords used by a user to successfully log onto a web page or application with said password safe application.

20. The mobile terminal-based automatic logon system according to claim 17, wherein said tag acquisition module comprises:
a logon list acquisition unit that, when the user successfully logs on said password safe application, the user may acquire said logon list; and
a tag acquisition unit for acquiring and selecting the tag corresponding to said target web page or said target application according to said logon list.
